(19) United States
(12) Patent Application Publication
(10) Pub. No.: US 2006/0007921 A1
(43) Pub. Date: Jan. 12, 2006

(54) Voice file generating system

(75) Inventor: Takuya Shimomura, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/172,994

(22) Filed: Jul. 5, 2005

(30) Foreign Application Priority Data
Jul. 12, 2004 (JP) 2004-204942

(51) Int. Cl. H04L 12/66

(52) U.S. Cl. 370/352

(57) ABSTRACT

The present invention provides a voice file generating system which generates a voice file in a reproduction format which is a voice reproduction format specific to the model of a cellular phone which accesses the system in accordance with access information embedded in a two-dimensional code, comprising a receiving section which receives a voice file in a recording format different from the reproduction format and a converting section which converts the received voice file in the recording format to the voice file in the reproduction format of a sound quality in a given range so that the voice file is reduced to a size that can be downloaded to the cellular phone.

### BACKGROUND OF THE INVENTION

1. Field of the Invention

The present invention relates to a voice file generating system and in particular to a system for generating an voice file to be provided to a cellular phone which accesses the system on the basis of access information embedded in a two-dimensional code.

2. Related Art

Information systems that read barcodes to deliver contents such as images and text have been developed. For example, the information providing system disclosed in Japanese Patent Application Laid Open No. 2002-312269 includes a display medium, such as a card, postcard, poster, or magazine, on which a barcode is printed, a barcode reader which reads the barcode, a terminal device which sends read information and displays and outputs returned information, a delivery information database which is connected to the terminal device through a communication network and saves and stores information corresponding to the barcode, a device to which an order for creation of a display medium such as a card is provided, a device which registers and stores information to be sent back in the database, and a device which sends information corresponding to the barcode to the terminal device, and a device which generates a unique barcode.

### SUMMARY OF THE INVENTION

The patent document disclosing the information system makes no mention of in what format a content to be delivered is created. Especially if a content is voice which is to be delivered to a cellular phone, the telephone voice may be converted to a digital voice file and stored on a CTI (Computer Telephony Integration) system and then the voice file may be converted to the telephone voice, which is sent to the cellular phone. However, the user who wants to receive the voice delivery must call the CTI system from the cellular phone in order to listen to the voice message. The call operation is troublesome and, in addition, the user is charged each time the user calls the CTI system. The present invention has been made in light of the problem and an object of the present invention is to provide a system which generates a voice file which can be reproduced on a cellular phone with a high-quality sound.

In order to solve the problem, a first aspect of the present invention provides a voice file generating system which generates a voice file in a reproduction format which is specific to the model of a cellular phone which accesses the system in accordance with access information embedded in a two-dimensional code, including: a receiving section which receives a voice file in a recording format different from the reproduction format; and a converting section which converts the received voice file in the recording format to the voice file in the reproduction format of a sound quality in a given range so that the voice file is reduced to a size that can be downloaded to the cellular phone.

According to the first aspect of the present invention, a voice file received is converted to a voice file in a reproduction format with a sound quality in a given range in a manner that the voice file is reduced to a size that can be downloaded to a cellular phone. Therefore, voice files of a sound quality in a given range and of a size capable of being downloaded to cellular phones can be generated for individual cellular phone models. Once the voice file in the reproduction format has been downloaded to a cellular phone, the voice of the given sound quality can be reproduced without needing to repeatedly access a server which delivers contents.

A second aspect of the present invention provides the voice file generating system according to the first aspect, further including a CTI (Computer Telephony Integration) server which records voice received from a telephone in the voice file in the recording format, wherein the receiving section receives the voice file in the recording format from the CTI server.

Voice that can be recorded in a voice file in a reproduction format may be a WAV file recorded on a CTI server.

A third aspect of the present invention provides the voice file generating system according to one of the first and second aspects, further comprising a downloading section which downloads the voice file in the reproduction format to the cellular phone.

According to the third aspect of the present invention, a voice file received is converted to a voice file in a reproduction format with a sound quality in a given range in a manner that the voice file is reduced to a size that can be downloaded to a cellular phone. Therefore, voice files of a sound quality in a given range and of a size capable of being downloaded to cellular phones can be generated for individual cellular phone models. Once the voice file in the reproduction format has been downloaded to a cellular phone, the voice of the given sound quality can be reproduced without needing to repeatedly access a server which delivers contents.

### BRIEF DESCRIPTION OF THE DRAWINGS

FIG. 1 schematically shows a functional configuration of a delivery system according to a preferred embodiment of the present invention;

FIG. 2 is a conceptual diagram illustrating order information;

FIG. 3 is a conceptual diagram illustrating template information;

FIG. 4 is a flowchart showing a flow of a delivery process;

FIG. 5 shows an example of a Web page which lists template images;

FIG. 6 shows an example of a Web page which receives the upload of a photo image to be printed;

FIG. 7 shows an example of a Web page on which a voice file to be uploaded is specified;

FIG. 8 shows an example of a Web page which provides a preview of a photo print; and

FIG. 9 shows an example of a QR code of a size that allows a code reading section to read access information displayed on a display device.

### DETAILED DESCRIPTION OF THE PREFERRED EMBODIMENTS

A preferred embodiment of the present invention will be described below with reference to the accompanying drawings.

[Schematic Configuration]

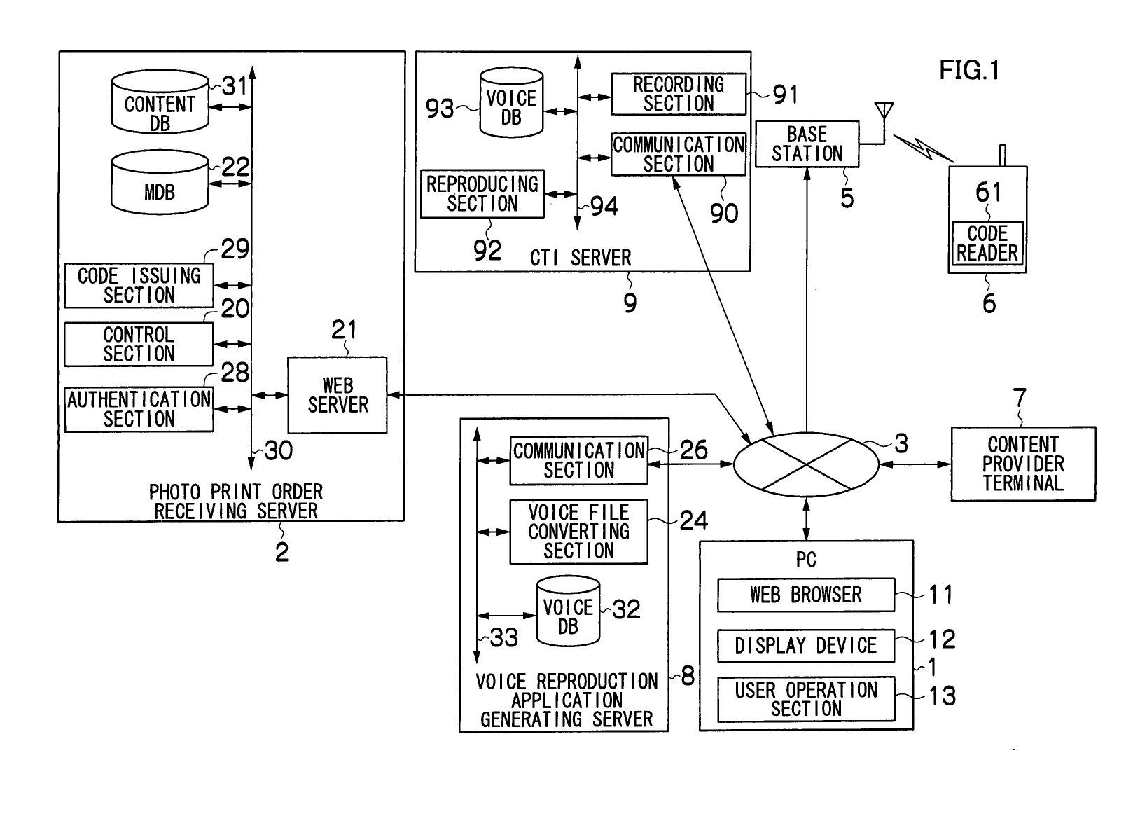

FIG. 1 schematically shows a functional configuration of a delivery system which uses a voice reproduction application generating server 8 according to a preferred embodiment of the present invention. The system includes a personal computer 1, a photo print order receiving server 2 (hereinafter simply referred to as the order receiving server), a voice reproduction application generating server 8, and a CTI (Computer Telephony Integration) server 9, which are interconnected through a network 3. While only one personal computer 1 is shown in FIG. 1, multiple personal computers 1 can be connected to the order receiving server 2 in some implementations. The order receiving server 2 includes an authentication section 28, which authenticates a connection from each personal computer 1 to the order receiving server 2 by using unique identification information inputted from the personal computer 1 (for simplicity, it is assumed that the identification information is a user ID and password but the information may be the telephone number of a cellular phone 6 or a user fingerprint information). Accordingly, each of the multiple personal computers 1 connected can be identified. A personal computer 1 includes a Web browser 11, which requests a Web server 21 to send a Web page identified by a URL (Unique Resource Locator) inputted through a user operation section 13 implemented by a keyboard or a mouse and displays the received Web page on the display screen of a display device 12.

The order receiving server 2 issues a two-dimensional code in which access information for accessing a content such as voice or an image is embedded through a code issuing section 29 and receives an order for printing a photo image which is uploaded from a personal computer 1 and to which a two-dimensional code is attached. The order receiving server 2 includes a control section 20, a Web server 21, a management database (MDB) 22, a code issuing section 29, and a content database (content DB) 31. The MDB 22 stores order information sent from personal computers 1. The content DB 31 stores contents. Order information stored in the MDB 22 can be used to generate a photo print containing a photo print image and an attached two-dimensional code in which access information for accessing a content is embedded, which is not described herein in detail. The control section 20, implemented by a CPU, is connected with the Web server 21, the MDB 22, the code issuing section 29, and the content DB 31 through a bus 30, and controls operations of components of the order receiving server 2. The Web server 21 also receives an uploaded voice file in a format recordable and reproducible on a personal computer 1 (hereinafter referred to as a recording format) from the personal computer 1. Examples of recording-format voice files include WAV files.

The CTI server 9 includes a communication section 90, a recording section 91, a reproducing section 92, and a voice DB 93. The communication section 90 connects to a base station 5 of a mobile communication network and to the network 3 and performs voice and data communications with the order receiving server 2, the voice reproduction application generating server 8, or a cellular phone 6. A given telephone number is assigned to the communication section 90. The recording section 91 records a telephone voice received at the communication section 90 in a voice file in a recording format and stores the voice file in the voice DB 93. The reproducing section 92 reproduces a telephone voice and sends the telephone voice through the communication section 90 to a cellular phone 6 or other telephone that has called the given telephone number. The recording section 91 and the reproducing section 92 may receive a record/reproduce instruction as a push-tone signal inputted from a telephone that calls the telephone number of the communication section 90. When receiving a record instruction, the recording section 91 may record a voice message sent from the telephone; when receiving a reproduce instruction, the reproducing section 92 may reproduce a voice message from a particular voice file in the voice DB 93 and send it to the telephone.

The voice reproduction application generating server 8 includes a voice file converting section 24, a communication section 26, and a voice database (voice DB) 32. The communication section 26 is connected to the network 3 and the voiced database (voice DB) 32 is temporarily stores a recording-format voice file received at the communication section 26 from the order receiving server 2 or the CTI server 9. The voice file converting section 24 converts a recording-format voice file in the voice DB 32 to a reproduction format specific to the model of a cellular phone 6 so that the file is reduced to a size that can be downloaded to the cellular phone 6 with a sound quality in a given range. If there are multiple reproduction formats specific to the models of the cellular phones 6, the file is converted to each of the reproduction formats. The voice file in the reproduction format is an application written in a language such as Java® that can be executed on the cellular phone 6. The file size that can be downloaded to a cellular phone 6 depends on the communication environment of the base station 5 or the model and performance of the cellular phone 6. If the file size that can be downloaded to a cellular phone 6 differs from model to model, the smallest size among the file sizes may be used as the size of the in reproduction-format voice file size.

A voice file in a reproduction format can be downloaded to cellular phones 6 of any models at least if the size of the voice file in a recording format is a size that can be downloaded to any cellular phone 6 models. However, it is also necessary to ensure that the reproduction-format voice file is of a sound quality that can communicate the meaning of what the voice says clearly when the file is reproduced on a cellular phone 6. Suppose that a cellular phone 6 has the function of reproducing a voice file in ADPCM (Adaptive Differential Pulse Code Modulation) format but the quantifying bit number of the ADPCM is fixed at 4 bits and the voice file size that can be downloaded to the cellular phone 6 is limited to 20 KB or less. If the sampling frequency of ADPCM is 8 kHz, then the amount of data required for voice reproduction for 1 second is 8 kHz×0.5 bytes (4 bits)=4 k bytes. Therefore, the reproduction time (theoretical value) of a downloadable voice file of 20 k bytes is 20 k bytes/4 k bytes=5 seconds. In practice, the reproduction time will be less than 5 seconds because a voice file has a header portion of several tens of bytes. In this way, the ADPCM reproduction function of a cellular phone 6 with a sampling frequency of 8 kHz and a quantifying bit number of 4 bits can reproduce voice for up to 5 seconds (theoretical value) in a sound quality equivalent to telephone voice of a sampling frequency of 8 kHz and a quantifying bit number of 4 bits. Of course, the sampling frequency may be increased to improve the sound quality, or the reproduction time may be increased with the same sampling frequency as the downloadable file size increases with changes of the specifications of cellular phones 6. The reproduction time would be able to be increased to 10 seconds (theoretical value) by reducing the sampling frequency of ADPCM to 4 kHz. However, the sound quality would then be degraded to a level where the message becomes difficult to recognize.

The communication section 26 obtains a voice file from the voice DB 32 stored in a storage location identified by access information for a cellular phone 6 that accesses it according to the access information, and downloads the voice file to the cellular phone 6.

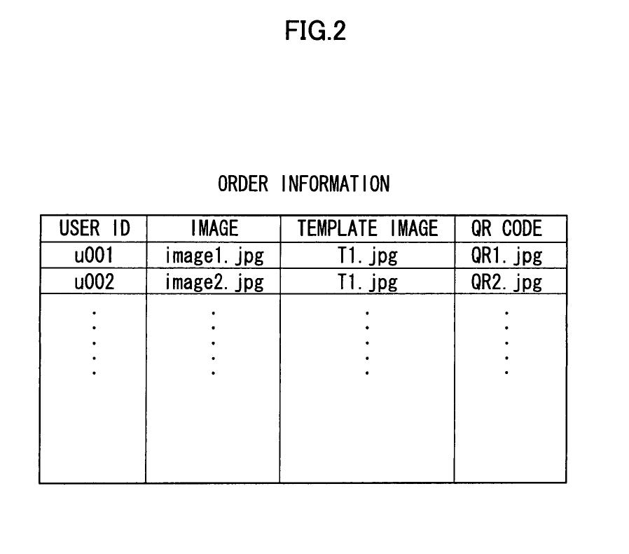

FIG. 2 shows a conceptual diagram illustrating order information stored in the management database (MDB) 22. In the order information, User IDs are associated with images, template images, and QR codes. The user IDs are obtained by the authentication section 28 from personal computers 1. The images are uploaded from personal computers 1 to the order receiving server 2 for photo printing. The template images are pre-stored in the content DB 31 and used as templates to be combined with uploaded images. Embedded in a QR code is access information for accessing a content stored in the content DB 31, the voice DB 32 or 93, in particular, the storage location of a reproduction-format voice file stored in the voice DB 32 (represented by an address such as the URL of a download site). Because QR codes are attached to and printed with photo images to be printed, they are stored as image files in the MDB 22.

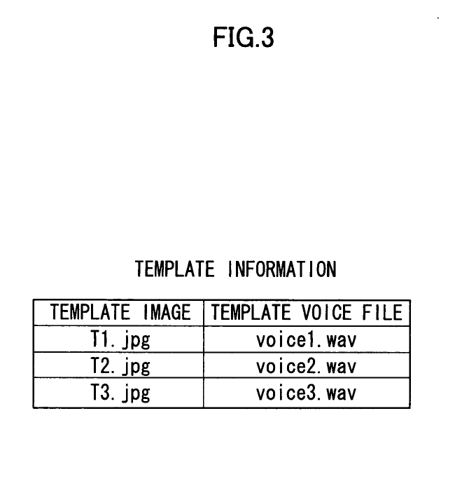

As shown in FIG. 3, the content DB 31 contains template information in which template images are associated with template voice files. Any one of the template images stored in the content DB 31 can be selected through an operation on the user operating section 13 of a personal computer 1. The template voice files are voice files in a recording format. A template image can be associated with a template voice file in any manner; a template image originally created may be associated with a voice file suitable for the content of the template image and stored in the content DB 31 from a content provider terminal 7 which is a personal computer used by a content provider different from a print orderer authenticated by the authentication section 28. The content provider may pay a charge for the use of the content DB 31 to the operator of the order receiving server 2 and may receive a predetermined fee from the personal computer 1 according to the number of ordered print copies.

A cellular phone 6 is used by a user of a personal computer 1 authenticated by the order receiving server 2, or other user. The cellular phone 6 has a code reader 61 which reads information embedded in a two-dimensional code such as a QR code. While for simplicity it is assumed herein that the two-dimensional codes are QR codes, any of various types of two-dimensional codes such as PDF 417, Datacode, and Maxicode may be used instead of QR codes. If a cellular phone 6 has a device which reads barcodes, barcodes may be used instead of two-dimensional codes.

[Process Flow]

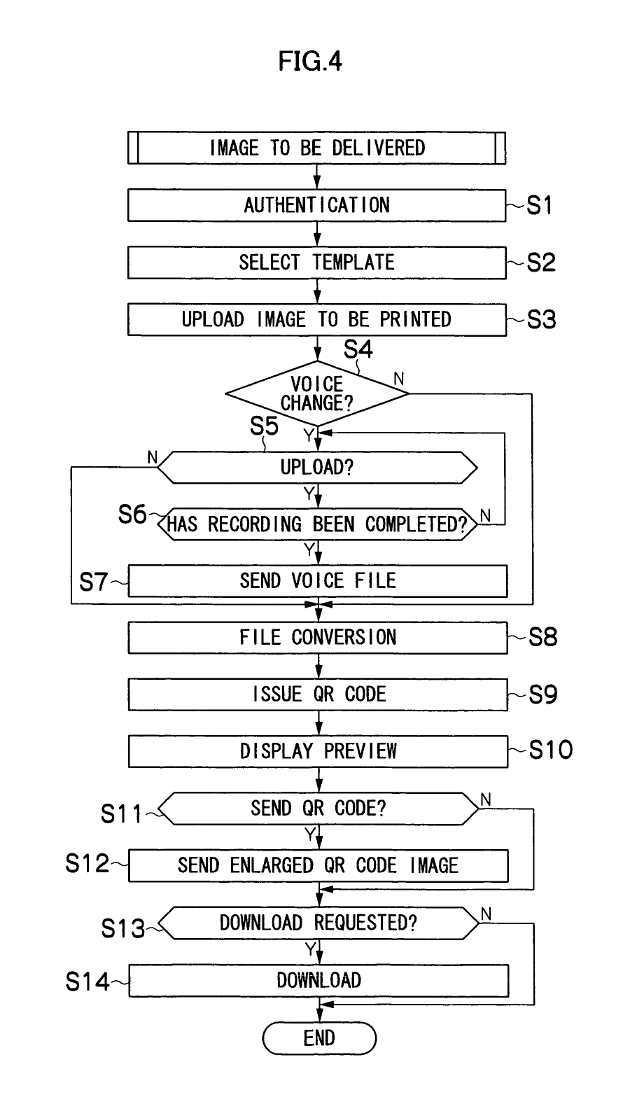

A flow of a delivery process performed by the delivery system will be described below with respect to a flowchart shown in FIG. 4.

At S1, the order receiving server 2 authenticates a personal computer 1 accessing it on the basis of a user ID and a password sent from the personal computer 1. The personal computer 1 is subsequently identified by the user ID used in the authentication.

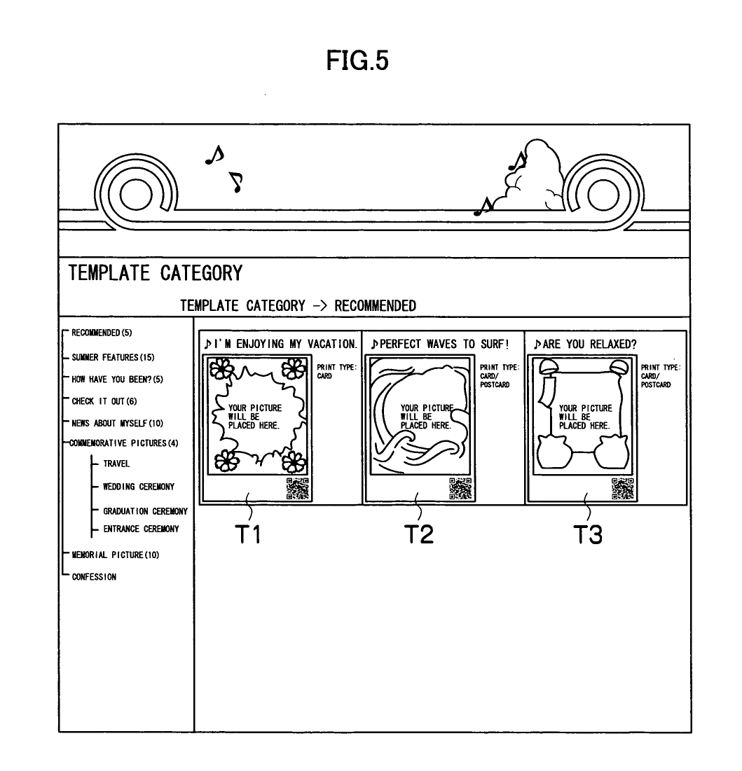

At S2, the order receiving server 2 sends a Web page which lists template images stored in the content DB 31 to the personal computer 1 to allow a user to select one from among the listed template images. FIG. 5 shows an example of the Web page which lists template images. Template images T1-T3 are displayed on the exemplary Web page shown in FIG. 5. The personal computer 1 receives the selection of a template image performed by an operation on the user operation section 13 such as a click on the template images T1-T3 and notifies the identifier of the selected template image to the order receiving server 2. It is assumed in the following description that template image T1 is selected.

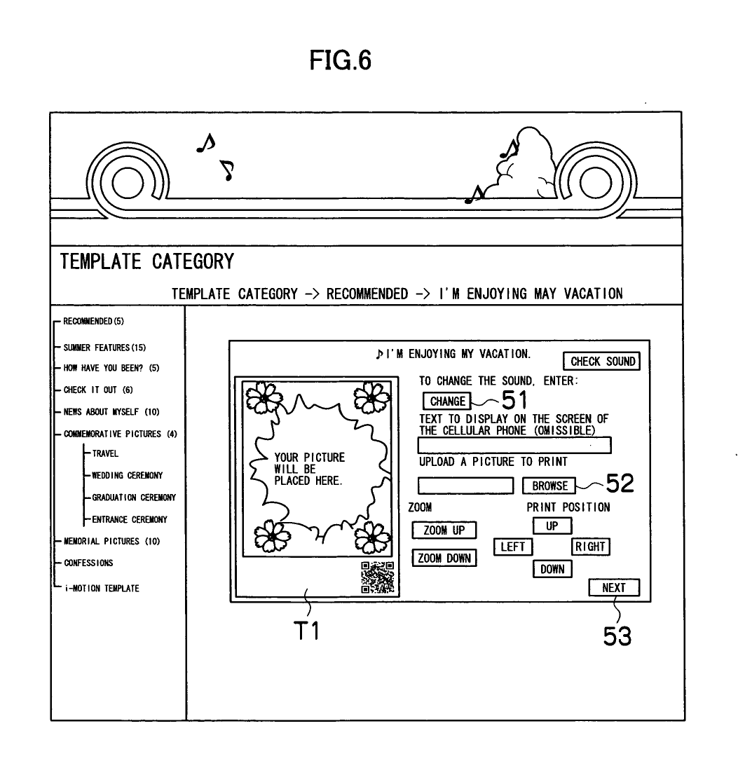

At S3, the order receiving server 2 receives upload of a photo image to be printed from the personal computer 1. The upload of a photo image to be printed can be received through a Web page sent to the personal computer 1 from the Web server 21, as shown in FIG. 6. That is, an image stored on the personal computer 1 can be selected by pressing a Browse button 52 on the page. By this selection, the image to be uploaded is specified. On the completion of the specification, the personal computer 1 sends the specified image to the order receiving server 2. The template image selected at S2 is displayed in an enlarged scale so that user can check image. The image uploaded from the personal computer 1 is associated and with the user ID authenticated at S1 stored in the MDB 22.

At S4, the order receiving server 2 receives the specification as to whether the template voice file associated with the template image selected at S2 should be changed as voice attached to a photo image to be printed. If change of the template voice file is specified, the process proceeds to S5. If change is not specified, the template voice file associated with the template image selected at S2 is retrieved from the content DB 31 and sent to the voice reproduction application generating server 8 in association with the user ID authenticated at S1. The voice reproduction application generating server 8 stores the received voice file in the voice DB 32 in association with the user ID, and then proceeds to S8. Change of the voice file can be determined on the basis of whether the Change button 51 is pressed on the Web page shown in FIG. 6, for example.

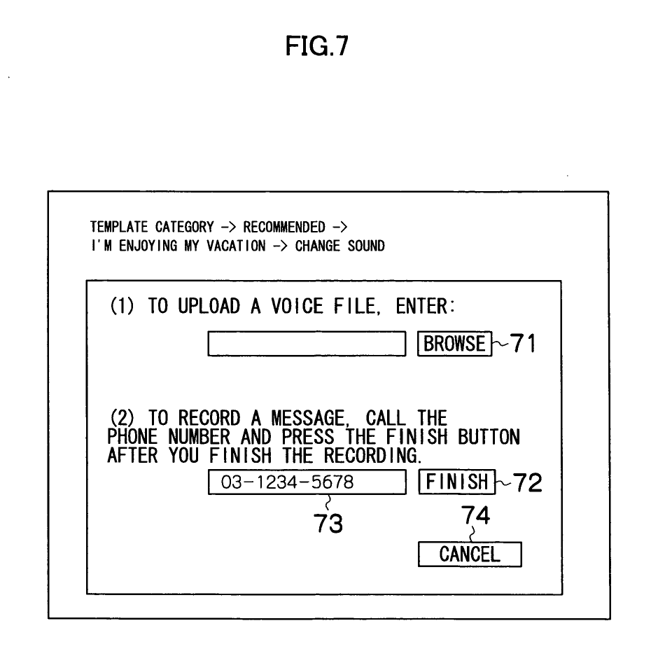

At S5, order receiving server 2 receives specification as to whether a recording-format voice file should be uploaded from the personal computer 1 as voice attached to the photo image to be printed. If a voice file is specified, the order receiving server 2 receives the upload of the specified voice file from the personal computer 1 and sends the uploaded voice file to the voice reproduction application generating server 8 in association with the user ID. The voice reproduction application generating server 8 stores the received voice file in the voice DB 32 in association with the user ID and then proceeds to S8. On the other hand, if no voice file is specified from the personal computer 1, the process proceeds to S6. These specifications can be received through a Web page as shown in FIG. 7. If the Browse button 71 is pressed, a voice file can be selected from among the voice files stored on the personal computer 1 can be selected. If a selection is made, the selected file is specified as the voice file to be uploaded. On the completion of the specification, the personal computer 1 sends the specified voice file to the order receiving server 2. If the Browse button 71 is not pressed, the process proceeds to S6.

At S6, the order receiving server 2 receives specification as to whether voice recorded in the recording section 91 should be attached to the photo image to be printed. If it is specified that the voice should be attached, the process proceeds to S7; if not, the process returns to S5. This can be determined on the basis of whether the Finish button 72 on the Web page shown in FIG. 7 is pressed. The predetermined telephone number 73 assigned to the communication section 90 is displayed on the Web page in FIG. 7. The recording section 91 converts the telephone voice in the telephone call to the telephone number 73 into a recording-format voice file and stores it in the voice DB 93. The recording section 91 stores the voice file in association with the user ID authenticated at S1 and manages associations between voice files and user IDs.

At S7, the communication section 90 retrieves a voice file associated with user ID authenticated at S1 from the voice DB 93 and sends the retrieved voice file to the voice reproduction application generating server 8 in association with the user ID. The voice reproduction application generation server 8 stores the received voice file in the voice DB 32 in association with the user ID.

At S8, the voice file converting section 24 retrieves a recording-format voice file associated with the user ID authenticated at S1 from the voice DB 32 and converts the voice file to a reproduction format so that the file is reduced to a size downloadable to the cellular phone 6 in a predetermined range of sound quality. The converted voice file in the reproduction format is stored in the voice DB 32 in association with the user ID. After the completion of this process, the recording-format voice file associated with the user ID authenticated at S1 may be deleted from the voice DB 32.

At S9, the code issuing section 29 issues a QR code in which information for accessing the reproduction-format voice file stored in the voice DB 32 at S8 is embedded and stores the QR code in the MDB 22 in association with the user ID authenticated at S1.

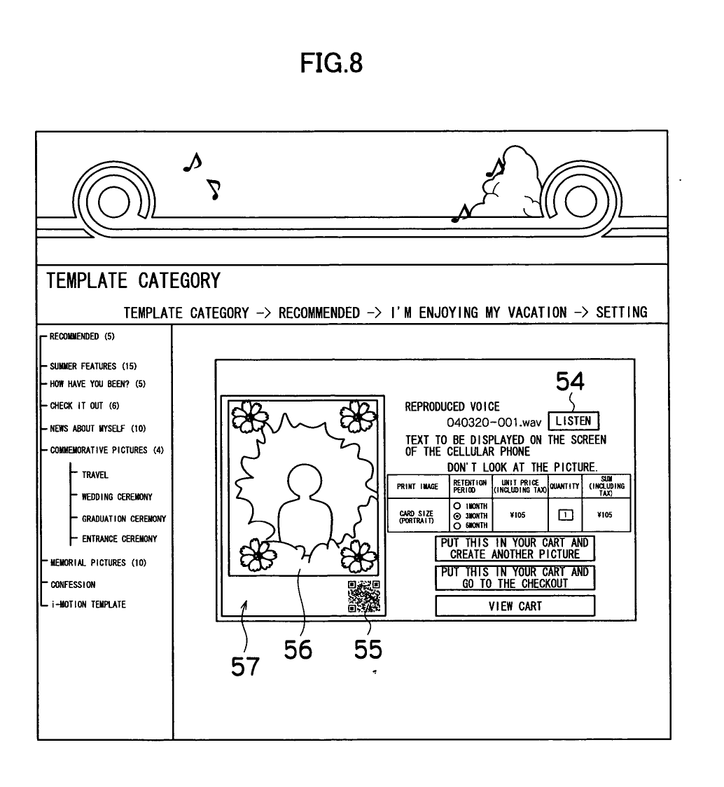

At S10, the order receiving server 2 sends to the personal computer 1 a Web page which provides a preview of a photo print in which the photo image uploaded at S3 for printing is combined with the template image selected at S2 and to which the QR code issued at S9 is attached. FIG. 8 shows an example of the preview display. Displayed on the Web page shown in FIG. 8 is a preview image 57 of a composite image 56 in which the template image selected at S2 is combined with the print photo image uploaded at S3 and to which a reduced image 55 of the QR code issued at S9 is attached. By pressing the Listen button 54 on this display, the recording-format voice file associated with the user authenticated at S1 can be downloaded from the voice DB 32 to the personal computer 1 and reproduced. Thus, the voice to be attached to the photo print can be pre-checked on the personal computer 1.

At S11, the order receiving server 2 determines whether it is requested to send the issued QR code of a size that allows the code reader 61 to read the access information from the QR code displayed on the screen of the display device 12 of the personal computer 1. If it is requested, the process proceeds to S12; otherwise the process proceeds to S13. The request can be sent from the personal computer 1 to the order receiving server 2 by clicking the reduced image 55 of the QR code in the preview image 57 to specify it.

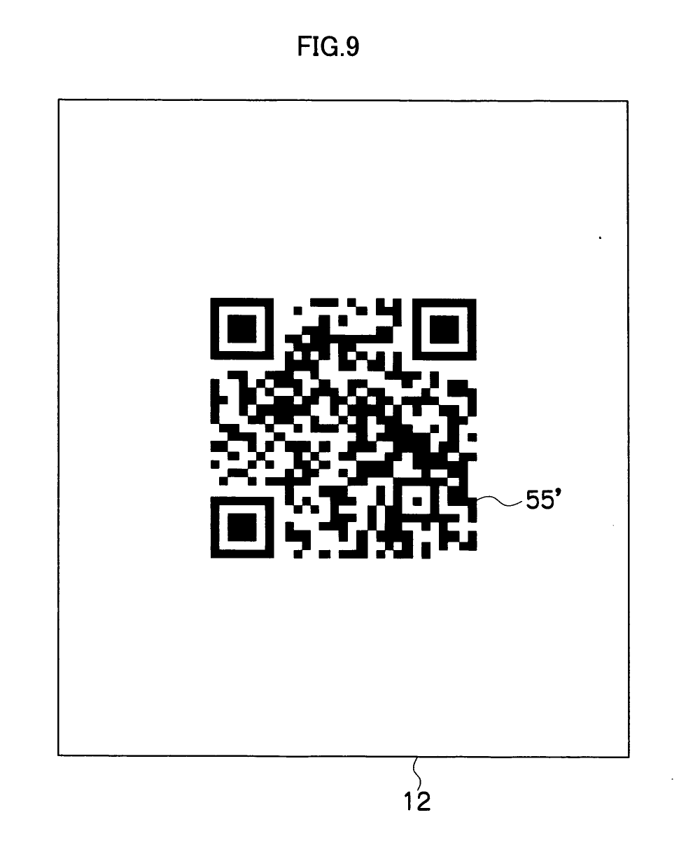

At S12, the order receiving server 2 sends to the personal computer 1 the image of the QR code enlarged to a size that allows the code reader 61 to read the access information from the QR code displayed on the screen of the display device 12 of the personal computer 1. As shown in FIG. 9, the QR code image 55′ displayed on the screen of the display device 12 is of a size such that the access information can be read by the code reader 61 of the cellular phone 6.

At S13, the voice reproduction application generating server 8 determines whether or not the cellular phone 6 has read the access information embedded in the image 55′ or the access information in the QR code attached to the photo print and is requesting the download of the voice file in the voice DB 32 that is identified by the access information. It the download is requested, the process proceeds to S14, where the voice reproduction application generating server 8 retrieves the requested voice file in the reproduction format from the voice DB 32 and downloads it to the cellular phone 6. If the download is not requested, the process will end.

As has been described, the voice file converting section 24 converts the voice file in the recording format into the reproduction format in the predetermined sound quality range so that the file is reduced to a size that can be downloaded to the cellular phone 6, and stores the file in the voice DB 32. While the voice file is in a format specific to the model of the cellular phone 6, the voice file can be converted to a reproduction format specific to a different model. Once the voice file in the reproduction format has been downloaded to the cellular phone 6, the voice of a proper quality can be reproduced on the cellular phone 6 without accessing the CTI sever 9 or the voice reproduction application generating server 8.

The voice reproduction application generating server 8 can update a generated voice file in a reproduction format. For example, a photo print with a QR code in which the telephone number assigned to the communication section 90 is embedded as access information may be delivered to the user of the cellular phone 6 with or without charge as a print for changing voice. If the user reads the access information by using the cellular phone 6 and calls the communication section 90 and then performs a push-tone operation for starting to record, the recording section 91 may record the telephone voice received from the cellular phone 6. On the completion of the telephone communication from the cellular phone 6, the voice file converting section 24 converts the voice file in the recording format to a reproduction format as described with reference to S8, and stores the voice file in the voice DB 32 in association with the user ID. This overwrites the reproduction-format voice file stored in the voice DB 32 in association with the same user ID.

The newly generated reproduction-format voice file can be checked by reading the access information for accessing the voice DB 32 that is embedded in the QR code attached to the photo print by means of the cellular phone 6 and downloading and executing the reproduction-format voice file as described with reference to S13 and S14. However, if the download of the voice file stored in the voice DB 32 is requested while the voice file in the reproduction format is being generated, the old reproduction-format voice file can be downloaded and the user can misunderstand that voice has not been updated. To prevent this, if downloading of a reproduction-format voice file is requested while it is being generated, the voice reproduction application generating server 8 may notify the cellular phone 6 that the reproduction-format voice file is being generated and may reject the request for downloading the voice file.

What is claimed is:

1. A voice file generating system which generates a voice file in a reproduction format which is a voice reproduction format specific to the model of a cellular phone which accesses the system in accordance with access information embedded in a two-dimensional code, comprising:
a receiving section which receives a voice file in a recording format different from the reproduction format; and
a converting section which converts the received voice file in the recording format to the voice file in the reproduction format of a sound quality in a given range so that the voice file is reduced to a size that can be downloaded to the cellular phone.

2. The voice file generating system according to claim 1, further comprising a CTI (Computer Telephony Integration) server which records voice received from a telephone in the voice file in the recording format, wherein the receiving section receives the voice file in the recording format from the CTI server.

3. The voice file generating system according to claim 1, further comprising a downloading section which downloads the voice file in the reproduction format to the cellular phone.

4. The voice file generating system according to claim 2, further comprising a downloading section which downloads the voice file in the reproduction format to the cellular phone.
